(19) United States
(12) Patent Application Publication
(10) Pub. No.: US 2017/0197598 A1
(43) Pub. Date: Jul. 13, 2017

(54) Determining Vehicle Length in a Road Train

(71) Applicant: Bendix Commercial Vehicle Systems LLC, Elyria, OH (US)

(72) Inventors: Michael K. Lesher, North Ridgeville, OH (US); Daniel P. Zula, North Ridgeville, OH (US)

(21) Appl. No.: 14/993,572

(22) Filed: Jan. 12, 2016

(51) Int. Cl. B60T 8/17; G01S 19/52; B60T 8/1755; G01S 19/51; B60T 8/171; B60T 8/175

(52) U.S. Cl. CPC B60T 8/1708; B60T 8/171; B60T 8/175; B60T 8/17551; G01S 19/51; G01S 19/52; B60T 2201/02; B60T 2250/04; B60T 2270/10; B60T 2270/30

(57) ABSTRACT

A system for determining the length of a road train includes controllers on both towing and towed vehicles. Each controller may transmit a vehicle length and GPS coordinates in a specified wireless message format. The towing vehicle controller receives a first wireless message from the towed vehicle controller. The wireless message includes at least one of a speed of the towed vehicle, a length of the towed vehicle and GPS coordinates of the towed vehicle. The towing vehicle controller determines if the towed vehicle transmitting the message is coupled to the towed vehicle and then adds the length of the towed vehicle to the length of the towing vehicle to attain an overall length of the road train in response to the determination that the towed vehicle transmitting the wireless message is coupled to the towing vehicle. The towing vehicle controller then transmits the overall length of the road train.

### BACKGROUND

The present invention relates to embodiments of a controller and a method for determining vehicle length in a road train. Increasingly, vehicles are being equipped with Vehicle to Vehicle (V2V) communication capabilities to improve a driver's awareness of the other vehicles sharing the same roadway. A basic message transmitted by a vehicle using V2V communication may include the type of vehicle, the computed mass of the vehicle and the length of the vehicle. This information can be used for collision mitigation by the vehicle receiving the message. In the instance of a commercial tractor trailer, or “road train,” the length of the vehicle can vary as trailers are added or removed. Individual trailer length can vary from about twenty five (25) feet to about sixty (60) feet, while a tractor length can vary from about eight (8) feet to about twenty two (22) feet. Therefore, to establish the overall length of the road train, each tractor must know to what trailers(s) it is connected. Additionally, when a tractor knows the number of trailers attached to it, the tractor safety systems can use the information for features such as stability control, since the parameters can be adjusted to improve performance for the size of the vehicle. Therefore, there is a need for a tractor to be able to accurately determine the entire length and mass of a tractor trailer combination vehicle and transmit this information to other vehicles on the roadway.

### SUMMARY

Various examples of an apparatus for determining the length of a road train comprise a processor having control logic. The control logic is capable of receiving a message at a towing vehicle from at least one towed vehicle transmitter, the message comprising at least one of a GPS coordinate of the towed vehicle, a length of the towed vehicle, a speed of the towed vehicle and a heading of the towed vehicle. The control logic is also capable of determining if the at least one towed vehicle is coupled to a towing vehicle and determining the overall length of the road train based on adding the length of the towed vehicle to the length of the towing vehicle in response to determining the at least one towed vehicle is coupled to the towing vehicle. The control logic is further capable of transmitting a message comprising the length of the road train and at least one of a GPS coordinate of the towing vehicle and the heading of the road train.

Various examples of a controller on a host vehicle for determining a length of a road train comprise a wireless port for transmitting and receiving wireless messages; an input for receiving a speed of the host vehicle; a global positioning system (GPS) receiver; and control logic. The control logic has a memory programmed with the length of the host vehicle and is capable of receiving a first wireless message from an other vehicle at the wireless port subsequent to the host vehicle speed being greater than a predetermined speed. The wireless message includes at least a speed of the other vehicle, a length of the other vehicle and GPS coordinates associated with the other vehicle. The control logic is capable of determining if the other vehicle is coupled to the host vehicle; adding the length of the other vehicle to the length of the host vehicle to attain an overall length of the road train in response to the other vehicle being coupled to the host vehicle; and transmitting the overall length of the road train and at least one of the GPS coordinates associated with the host vehicle and the heading of the host vehicle.

Various examples of a method of determining a length of a road train comprise receiving a host vehicle speed and receiving a first wireless message from a first vehicle subsequent to the host vehicle speed being greater than a predetermined speed. The wireless message includes at least a speed of the first vehicle, a length of the first vehicle, a heading of the first vehicle and GPS coordinates associated with the first vehicle. The method also comprises determining if the first vehicle is coupled to the host vehicle and adding the length of the first vehicle to the length of the host vehicle to attain an overall length of the road train in response to the first trailer being coupled to the tractor.

Various examples of a system for determining the length of a road train includes a plurality of transmitters for transmitting messages and a tractor controller. The tractor controller has a GPS receiver and capable of receiving the messages from each transmitter. The tractor controller is capable of receiving a tractor speed; receiving a first message from a first transmitter subsequent to the tractor speed being greater than a predetermined speed, the first message including at least a speed of the vehicle on which the first transmitter is located, a length of the vehicle and GPS coordinates associated with the vehicle; and comparing the speed in the first message to the speed of the tractor. The tractor controller is further capable of adding the length of the first vehicle to the length of the tractor to attain an overall length of the road train in response to the speed information in the first message being equivalent to the speed of the tractor; and transmitting the overall length of the road train and GPS coordinates associated with the tractor.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a road train incorporating a system according to an example of this invention.

FIG. 2 illustrates a tractor controller according to an example of this invention.

FIG. 3 illustrates a flow chart for a method of determining the length of a road train according to an example of this invention.

FIG. 4 illustrates a flow chart for a method of determining the length of a road train according to another example of this invention.

### DETAILED DESCRIPTION

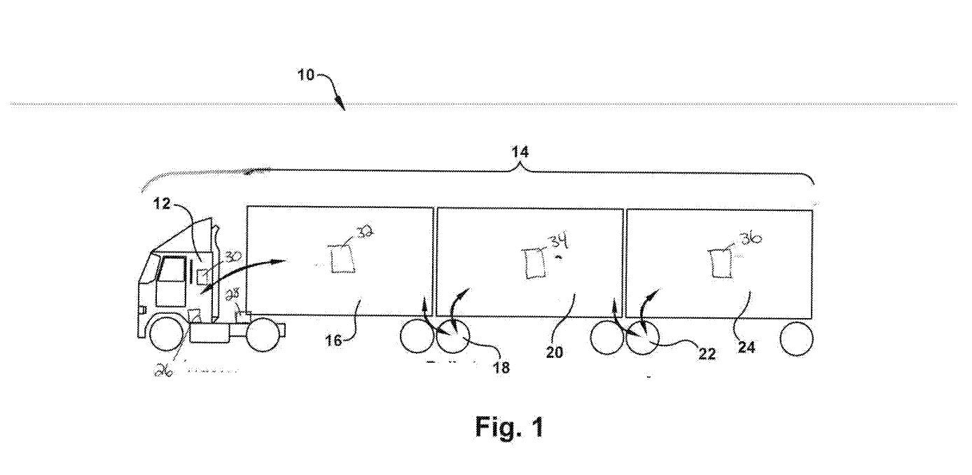

FIG. 1 illustrates a system 10 according to one example of the invention. The system 10 comprises a road train 14. The road train 14 shown in FIG. 1 includes a towing vehicle, such as tractor 12. The tractor 12 is electrically and pneumatically coupled to a towed vehicle, such as a first trailer 16. A first dolly 18 electronically and pneumatically couples the first trailer 16 to another towed vehicle, such as a second trailer 20. A second dolly 22 electronically and pneumatically couples the second trailer 20 to another towed vehicle, such as a third trailer 24. The number of towed vehicles in the road train 14 may change frequently based on the needs of the vehicle operator and local transportation regulations. The tractor 12 may be considered a “host vehicle” for the purposes of this invention. The trailers 16, 20, 24 may be considered “other vehicles” for the purposes of this invention. In addition, a “towing vehicle” may be a passenger car while the “towed vehicle” may be a storage trailer.

Each vehicle in the road train 14 is equipped with a controller capable of wireless communication. Tractor 12 includes a tractor controller 30. The tractor 12 also includes a braking controller 26 for controlling anti-lock and stability control functions on the tractor 12. The braking controller 26 communicates with the tractor controller 30 over a vehicle communications bus (not shown) or wirelessly. The tractor 12 may also include a weight measurement device 28. The weight measurement device 28 may be a pressure sensor located in the air suspension of the tractor 12 to estimate the combined vehicle weight of the road train 14. The weight measurement device 28 communicates with the braking controller 26. The combined vehicle weight may also be determined through the engine torque or other means.

The first trailer 16 includes a trailer controller 32, the second trailer 20 includes a trailer controller 34 and the third trailer 24 includes a trailer controller 36. Each dolly 18, 22 may also be equipped with a dolly controller (not shown). The tractor controller 30 and trailer controllers 32, 34, 36 may be equipped to facilitate Vehicle to Vehicle (V2V) communication among each controller and/or with other vehicles on the same roadway that are also equipped for V2V communication. Alternatively, the tractor controller 30 may communicate with the trailer controllers 32, 34, 36 through a wired communications bus, such as SAE J2497 Power Line Carrier Communications or other protocol.

For each trailer 16, 20, 24 the trailer controllers 32, 34, 36 may be affixed to any location on the trailer body. When each trailer 16, 20, 24 is a box trailer, the trailer controllers 32, 34, 36 may be affixed to the middle of the trailer body. Locating the trailer controllers 32, 34, 36 in nearly identical locations on each trailer is not required to determine trailer length and overall road train length, as will be explained.

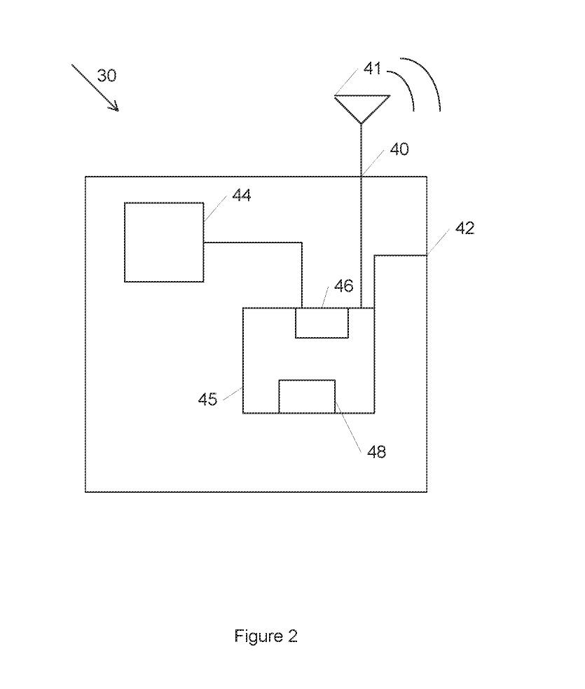

FIG. 2 illustrates the tractor controller 30 according to an example of this invention. Tractor controller 30 comprises a communications port 42 for receiving and transmitting information from the vehicle communications bus on the tractor 12. The tractor controller 30 comprises an antenna port 40 for receiving and transmitting wireless messages using antenna 41. The tractor controller 30 comprises a global positioning system (GPS) receiver 44 for receiving position information of the tractor 12 using the GPS protocol.

The tractor controller 30 includes a processor 45 with control logic 46 for receiving and transmitting the wireless messages at the antenna port 40 and receiving and transmitting communications bus messages at the communications port 42. The control logic 46 may include a memory 48, which may be a volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 46. The memory 48 may be preprogrammed with the length of the tractor 12. The processor 45 may also include a timer.

Some information received at the communications port 42 includes the host vehicle speed, host vehicle weight and diagnostic messages. Some information transmitted at the communications port 42 includes GPS coordinates and the overall length of the road train 14. The bus messages may be formatted in the SAE J1939 protocol or another protocol. The GPS receiver 44 receives coordinate information for the tractor 12. Some information transmitted at the antenna port 40 includes the coordinates as received by the GPS receiver 44, the length of the road train 14 and the heading of the road train 14. The wireless messages may be formatted in the SAE J2945 Dedicated Short Range Communications (DSRC) protocol or another protocol, such as Bluetooth, ZigBee or Wi-Fi. DSRC is a two-way short to medium range wireless communications capability that permits high data transmissions in vehicle applications. The transmission rate on the antenna port 40 may be about one hundred (100) milliseconds.

The trailer controllers 32, 34, 36 may be similar in construction and operation to the tractor controller 30. The trailer controllers 32, 34, 36 include communications ports and wireless ports. The trailer controllers 32, 34, 36 include processors having control logic with memory and may be preprogrammed with the length of the trailer 16, 20, 24. However the wireless transmission rate of the trailer controllers 32, 34, 36 may be slower than the transmission rate of the tractor controller 30, such as about one (1) second. In another example, the wireless transmission of the trailer controllers 32, 34, 36 may occur at the time when the seconds as measured by the GPS change from 59 to 00.

Therefore, various examples of an apparatus for determining the length of a road train comprise a processor having control logic. The control logic is capable of receiving a message at a towing vehicle from at least one towed vehicle transmitter, the message comprising at least one of a GPS coordinate of the towed vehicle, a length of the towed vehicle, a speed of the towed vehicle and a heading of the towed vehicle. The control logic is also capable of determining if the at least one towed vehicle is coupled to a towing vehicle and determining the overall length of the road train based on adding the length of the towed vehicle to the length of the towing vehicle in response to determining the at least one towed vehicle is coupled to the towing vehicle. The control logic is further capable of transmitting a message comprising the length of the road train and at least one of a GPS coordinate of the towing vehicle and the heading of the road train.

Furthermore, various examples of a controller on a host vehicle for determining a length of a road train comprise a wireless port for transmitting and receiving wireless messages; an input for receiving a speed of the host vehicle; a global positioning system (GPS) receiver; and control logic. The control logic has a memory programmed with the length of the host vehicle and is capable of receiving a first wireless message from an other vehicle at the wireless port subsequent to the host vehicle speed being greater than a predetermined speed. The wireless message includes at least a speed of the other vehicle, a length of the other vehicle and GPS coordinates associated with the other vehicle. The control logic is capable of determining if the other vehicle is coupled to the host vehicle; adding the length of the other vehicle to the length of the host vehicle to attain an overall length of the road train in response to the other vehicle being coupled to the host vehicle; and transmitting the overall length of the road train and at least one of the GPS coordinates associated with the host vehicle and the heading of the host vehicle.

Additionally, various examples of a system for determining the length of a road train include a plurality of transmitters for transmitting messages and a tractor controller. The tractor controller has a GPS receiver and capable of receiving the messages from each transmitter. The tractor controller is capable of receiving a tractor speed; receiving a first message from a first transmitter subsequent to the tractor speed being greater than a predetermined speed, the first message including at least a speed of the vehicle on which the first transmitter is located, a length of the vehicle and GPS coordinates associated with the vehicle; and comparing the speed in the first message to the speed of the tractor. The tractor controller is further capable of adding the length of the first vehicle to the length of the tractor to attain an overall length of the road train in response to the speed information in the first message being equivalent to the speed of the tractor; and transmitting the overall length of the road train and GPS coordinates associated with the tractor.

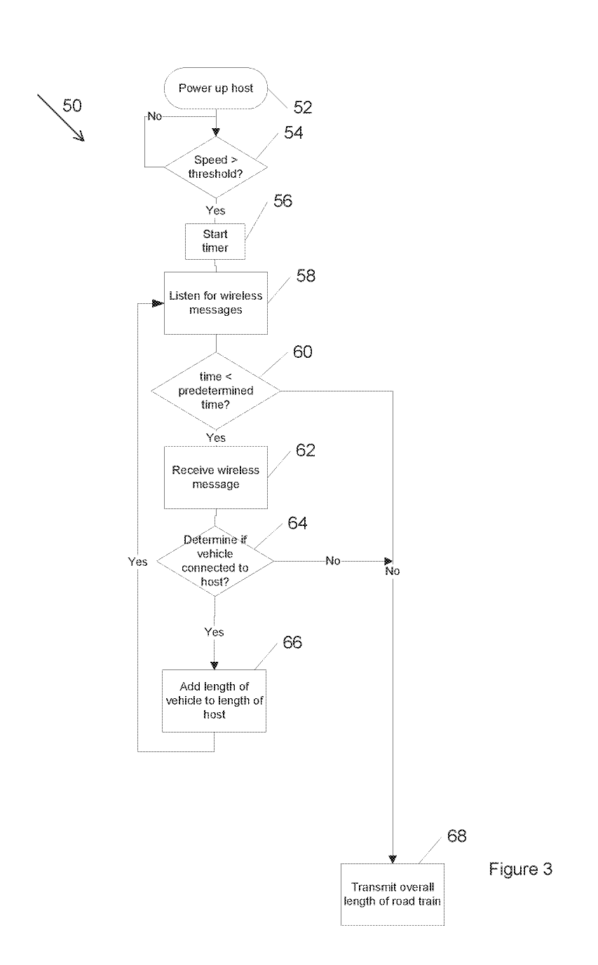

FIG. 3 illustrates a method 50 of determining the length of a road train according to an example of this invention. In step 52, the tractor controller 30 is powered up. In step 54, the speed of the tractor 12 is compared to a threshold speed. In one example, the threshold speed is between about five (5) miles per hour and about fifteen (15) miles per hour. The threshold speed is set at a point where the speed of the tractor 12 can be reliably attained by the components on the tractor 12, such as wheel speed sensors. In addition, the tractor 12 and any trailers that may be coupled to the tractor 12 would more likely be spaced longitudinally from each other when above the threshold speed. If the speed is equal to or less than a threshold speed, the method 50 remains at step 54. If the speed is greater than the threshold speed, the method 50 continues to step 56.

In step 56, a timer in the processor 45 is started. In one example, the timer can be synchronized with ignition power on or with the receipt of the first wireless message by the control logic 46.

In step 58, the control logic 46 listens for wireless messages on port 40. In step 60, the timer value is compared to a predetermined time value. In one example, the predetermined time value is about ten (10) seconds. The predetermined time value is set to a value equivalent to the time necessary for about ten (10) wireless messages to be sent from each trailer. The predetermined time value is set to allow multiple wireless messages to be broadcast, thereby accounting for signal interference or other interruptions. If the timer value equals or exceeds the predetermined time value, the method 50 proceeds to step 68. If the timer value is less than the predetermined time value, the method proceeds to step 62.

In step 62, a wireless message is received. The message may include information indicating the type of vehicle transmitting the message. If the wireless message is from a trailer, as identified in the message, the control logic 46 retains the message for use in determining the length of the road train 14. If the wireless message is from a different vehicle, such as a passenger car near the tractor 12, the wireless message is not used for determining the length of the road train. The identification of vehicle type as in the received message is used because the range of the wireless transmission protocol is up to about five hundred (500) feet.

In step 64, the control logic 46 determines if the vehicle that transmitted the wireless message is coupled to the tractor 12. For purposes of DSRC, the transmitted location of the vehicle is the geographical center of the vehicle's latitude and longitude. The altitude is defaulted to the ground. The control logic 46 can determine whether the vehicle is physically coupled to the tractor 12 in at least three different manners.

In a first example, the control logic 46 determines if the vehicle that transmitted the message is coupled to the tractor 12 by comparing the speed of the tractor 12 and the speed as in the received message. If the speed of the tractor 12 is within a predetermined speed of the speed as in the received message, for example about 0.5 miles per hour, then the control logic 46 adds the vehicle length as in the received message to the length of the tractor 12 to determine the overall length of the road train 14 in step 66.

In a second example, the control logic 46 compares the GPS coordinates of the tractor 12 with the GPS coordinates of received message. The control logic 46 determines that the vehicle which transmitted the message is coupled to the tractor 12 when the GPS coordinates of the tractor 12 place the tractor 12 within a predetermined proximity of the vehicle that transmitted the message. The predetermined proximity may be set as between about eighteen (18) feet and ninety (90) feet of the tractor 12 GPS coordinates to the rear of the tractor 12. If the proximity of the tractor 12 is within the predetermined proximity to the vehicle transmitting the message and the location is to the rear of the tractor 12, then the control logic 46 adds the vehicle length as in the received message to the length of the tractor 12 to determine the overall length of the road train 14 in step 66. Any messages with a GPS location placing the vehicle transmitting the message to the side of the tractor 12 would be rejected as the vehicle could not logically be coupled to the tractor 12. In this example, the GPS coordinates can also be used in place of adding together a preprogrammed trailer length with a preprogrammed tractor length. When the trailer controllers 32, 34, 36 are consistently placed in the same location on the trailer body, the GPS coordinates as in the received message can be used to determine the length of trailer and subsequently, the road train 14. The control logic 46, knowing the GPS coordinates of the tractor controller 30, can add the information regarding the GPS coordinates of the trailer controllers 32, 34, 36 to achieve the overall length of the road train 14. For example, if the GPS coordinates of the tractor 12 are N 41° 22′ 44.932″ and W 82° 4′ 17.749″ and the GPS coordinates of the received message are N 41° 22′ 45.088″ and W 82° 4′ 17.257″ then the control logic 46 adds the values between the GPS coordinates to determine the length of the vehicle transmitting the message. This length is added to the length of the tractor 12 in step 66.

In a third example, the control logic 46 compares the heading of the tractor 12 with the heading of the vehicle transmitting the message. If the heading of the tractor 12 is less than a predetermined angle threshold of the heading of the vehicle as in the received message, for example within two (2) degrees, then the control logic 46 determines that the tractor 12 is coupled to the vehicle transmitting the message and adds the length as in the received message to the length of the tractor 12 to determine the overall length of the road train 14 in step 66.

For additional accuracy in determining whether the vehicle transmitting the message is coupled to the tractor 12, any of the above examples can be combined. For example, the speed and the heading may be compared before determining the vehicle transmitting the message is coupled to the tractor 12. Alternatively, the GPS coordinates and the speed may be compared. In yet another example, the type of vehicle and the heading may be compared. In yet another example, the tractor 12 can compare when the tractor 12 is powered on with when the vehicle transmitting the message was powered on. If the tractor 12 power on time is equal to the power on time in the received message, then the determination can be made that the tractor 12 is coupled to the vehicle transmitting the wireless message. The vehicle transmitting the message may also transmit a message indicating a brake activation, which can be compared with a brake activation on the tractor 12.

In step 66, the received length or measured length of the vehicle transmitting the message is added to the tractor length programmed in the memory 48. For example, if the known tractor length is eighteen (18) feet and two trailers of twenty-five (25) feet each are determined to be attached to the tractor, then the overall road train length would be sixty-eight (68) feet. However, an additional six (6) feet may be added to account for a dolly, if the dolly was not equipped to be transmitting its own wireless message. The six feet between the two trailers also accounts for the standard gap allowed between trailers for maneuverability. Therefore, the overall length of the road train 14 would more accurately be seventy-four (74) feet.

If the control logic 46 determines the vehicle transmitting the message is not coupled to the tractor 12 in step 64, the method 50 proceeds to step 68.

After step 66 is completed, the method returns to step 58 to continue to listen for additional wireless messages. The method 50 continues until the timer value is equal to or greater than the predetermined time value in step 60. When the timer value is equal to or greater than the predetermined time, the method 50 proceeds to step 68. In step 68, the control logic 46 transmits the overall length of the road train 14 using the wireless port 40. The control logic 46 may also transmit the overall length via the communications port 42 for use by other safety systems on the tractor 12.

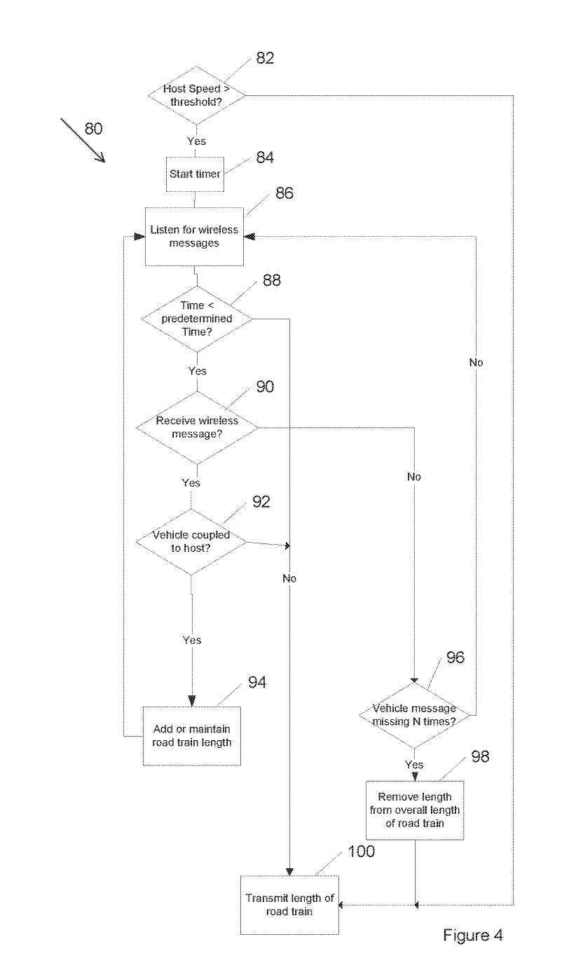

FIG. 4 illustrates a method 80 of determining the length of a road train 14 and transmitting the information in situations where the length of the road train has already been calculated, but must be determined again because a trailer might have been removed while the tractor controller 30 was still in the powered on state.

The method 80 begins at step 82 where the tractor speed is compared to the threshold speed, similar to step 54 in method 50. In one example, the threshold speed is between about five (5) miles per hour and about fifteen (15) miles per hour. If the speed is equal to or less than the threshold speed, the method 80 proceeds to step 100 and the previously calculated length of the road train 14 is transmitted as no updates to the vehicle length can be made while the vehicle is stopped or at a very low traveling speed. If the speed of the tractor 12 equals or exceeds the threshold speed, the method 80 continues to step 84.

In step 84 the timer in the processor 45 is started. In step 86, the control logic 46 listens for wireless messages on port 40. In step 88, the timer value is compared to a predetermined time value, similar to step 60 in method 50. In one example, the predetermined time value is about ten (10) seconds. If the timer value is less than the predetermined time value, the method 80 proceeds to step 90. If the timer value is greater than or equal to the predetermined time value, the method 80 proceeds to step 100 to transmit the overall length of the road train 14.

In step 90, the control logic 46 determines if a wireless message is received. If a wireless message is received, the method 80 continues to step 92. If no wireless message is received, the method 80 continues to step 96.

In step 92, the control logic 46 determines if the vehicle that transmitted the message is coupled to the tractor 12, similar to step 64 in method 50. In a first example, the control logic 46 determines if the vehicle that transmitted the message is coupled to the tractor 12 by comparing the speed of the tractor 12 and the speed as in the received message. If the speed of the tractor 12 is within a predetermined speed of the speed in the received message, for example about 0.5 miles per hour, then the control logic 46 adds the vehicle length as in the received message to the length of the tractor 12 to determine the overall length of the road train 14 in step 94.

In a second example, the control logic 46 compares the GPS coordinates of the tractor 12 with the GPS coordinates of received message. The control logic 46 determines that the vehicle which transmitted the message is coupled to the tractor 12 when the GPS coordinates of the tractor 12 place the tractor 12 within a predetermined proximity of the vehicle that transmitted the message. The predetermined proximity may be set as between about eighteen (18) feet and ninety (90) feet of the tractor 12 GPS coordinates to the rear of the tractor 12. If the proximity of the tractor 12 is within the predetermined proximity to the vehicle transmitting the message and the location is to the rear of the tractor 12, then the control logic 46 adds the vehicle length as in the received message to the length of the tractor 12 to determine the overall length of the road train 14 in step 94. Any messages with GPS coordinates placing the vehicle transmitting the message to the side of the tractor 12 would be rejected as the vehicle could not logically be coupled to the tractor 12. In this example, the GPS coordinates can also be used in place of adding together a preprogrammed tractor length and a preprogrammed trailer length. As stated previously, when the trailer controllers 32, 34, 36 are consistently placed in the same location, the GPS coordinates as in the received message can be used to determine the length of the road train 14. The control logic 46, knowing the GPS coordinates of the tractor controller 30, can add the information regarding the GPS coordinates of the trailer controllers 32, 34, 36 to achieve the overall length of the road train 14. For example, if the GPS coordinates of the tractor 12 are N 41° 22′ 44.932″ and W 82° 4′ 17.749″ and the GPS coordinates of the received message are N 41° 22′ 45.088″ and W 82° 4′ 17.257″ then the control logic 46 adds the values between the GPS coordinates to determine the length of the vehicle transmitting the message. This length is added to the length of the tractor 12 in step 94.

In a third example, the control logic 46 compares the heading of the tractor 12 with the heading of the vehicle transmitting the message. If the heading of the tractor 12 is less than a predetermined angle threshold of the heading of the vehicle as in the received message, for example within two (2) degrees, then the control logic 46 determines that the tractor 12 is coupled to the vehicle transmitting the message and adds the length as in the received message to the length of the tractor 12 to determine the overall length of the road train 14 in step 94.

If, however, the control logic 46 determines that the vehicle transmitting the wireless message is not coupled to the tractor in step 92, the method 80 continues to step 100.

After adding to or maintaining the length of the vehicle transmitting the message to the overall length of the road train 14 in step 94, the method 80 returns to step 86 to continue to listen for additional wireless messages. If the timer value is equal to or exceeds the predetermined time, the method 80 continues to step 100 and transmits the calculated overall length of the road train 14.

If no wireless message was received in step 90, the method 80 proceeds to step 96. The control logic 46 determines if the vehicle that had previously been part of the road train 14 did not send a message N consecutive times. N may set to an integer, such as three (3), to allow for missed wireless messages or delays in transmission of the message. If the number of times the expected wireless message is less than N, the method 80 increments N by one and returns to step 86 to continue to listen for wireless messages. If the number of times the expected wireless message was not received is equal to N, then the method 80 continues to step 98. In step 98, the length of the vehicle that had previously been part of the road train 14 is removed and a new length of the road train 14 is calculated. Using a prior example, the length of the road train 14 was determined to be seventy-four (74) feet. If a message from one trailer is no longer being received using method 80, the new calculated length of the trailer would be forty-three (43) feet. The method 80 continues to step 100 where the control logic 46 transmits the wireless message containing the calculated length of the road train 14 on the wireless port 40.

In yet another method, if no wireless messages are received, the tractor controller 30 may still make assumptions about the road train length based on the combined vehicle weight measured at the tractor. The combined vehicle weight may be measured at the air suspension of the tractor using weight measurement device 28, for example. If there are no wireless messages received by the tractor control logic 46 during the predetermined time and the weight measured at the tractor is only the estimated weight equivalent to the tractor itself, then the control logic 46 can assume that no towed vehicles are coupled to the tractor 12 and transmit only the length of the tractor. If the weight measured at the tractor is greater than the estimated weight equivalent to the tractor by itself, then the tractor control logic 46 can assume the longest available single trailer type, a sixty (60) foot trailer, is coupled to the tractor 12. The control logic 46 will then transmit the length of the tractor plus the trailer for an overall length of the road train 14 of seventy-eight (78) feet. From a safety standpoint, the control logic 46 assumes a longer length road train so that the vehicles sharing the roadway will keep a farther distance away from the road train 14.

If there are multiple trailers attached to the tractor 12 but fewer than all the trailers have a controller as described in this invention, the tractor control logic 46 can still make assumptions about the length of the overall road train 14 by using the GPS coordinates to establish approximately where in the road train 14 the vehicle transmitting the message is located.

Therefore, various examples of a method of determining a length of a road train comprise receiving a host vehicle speed and receiving a first wireless message from a first vehicle subsequent to the host vehicle speed being greater than a predetermined speed. The wireless message includes at least a speed of the first vehicle, a length of the first vehicle, a heading of the first vehicle and GPS coordinates associated with the first vehicle. The method also comprises determining if the first vehicle is coupled to the host vehicle and adding the length of the first vehicle to the length of the host vehicle to attain an overall length of the road train in response to the first trailer being coupled to the tractor.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. An apparatus for determining the length of a road train comprising:
a processor having control logic, the control logic capable of:
receiving a message at a towing vehicle from at least one towed vehicle transmitter, the message comprising at least one of a GPS coordinate of the towed vehicle, a length of the towed vehicle, a speed of the towed vehicle and a heading of the towed vehicle;
determining if the at least one towed vehicle is coupled to a towing vehicle in response to the message;
determining the overall length of the road train based on adding the length of the towed vehicle to the length of the towing vehicle in response to determining the at least one towed vehicle is coupled to the towing vehicle; and
transmitting a message comprising the overall length of the road train to a braking controller of the towing vehicle and transmitting a message to a vehicle independent of the road train comprising the overall length of the road train and at least one of a GPS coordinate of the towing vehicle and the heading of the road train.

2. The apparatus as in claim 1, wherein determining if the at least one towed vehicle is coupled to a towing vehicle comprises comparing the speed of the towed vehicle and the speed of the towing vehicle and determining the speed of the towed vehicle is within a predetermined speed of the speed of the towing vehicle.

3. The apparatus as in claim 1, wherein determining if the at least one towed vehicle is coupled to a towing vehicle comprises comparing the GPS coordinates of the towed vehicle with the GPS coordinates of the towing vehicle and determining that the GPS coordinates of the towed vehicle places the towed vehicle within a predetermined proximity of the towing vehicle.

4. The apparatus as in claim 1, wherein determining if the at least one towed vehicle is coupled to a towing vehicle comprises comparing the heading of the towed vehicle with the heading of the towing vehicle and determining that the heading of the towed vehicle is less than a predetermined angle threshold with the heading of the towing vehicle.

5. The apparatus as in claim 1, the control logic further capable of:
receiving a message at the towing vehicle from a second towed vehicle transmitter, the message comprising at least one of a GPS coordinate of the second towed vehicle, a length of the second towed vehicle, a speed of the second towed vehicle and a heading of the second towed vehicle;
determining if the second towed vehicle is coupled to a towing vehicle in response to the message; and
determining the overall length of the road train based on adding the length of the second towed vehicle to the length of the road train.

6. The apparatus as in claim 1, wherein the control logic is further capable of:
initiating a timer upon the at least one towing vehicle reaching a minimum speed;
comparing a value of the timer to a predetermined time value; and
determining if the at least one towed vehicle is coupled to the towing vehicle in response to value of the timer being less than the predetermined time value.

7. A host vehicle controller for determining a length of a road train comprising:
a wireless port for transmitting and receiving wireless messages;
an input for receiving a speed of the host vehicle;
a global positioning system (GPS) receiver; and
control logic, the control logic having a memory programmed with the length of the host vehicle and capable of:
comparing the host vehicle speed to a predetermined speed;
receiving a first wireless message from an other vehicle at the wireless port subsequent to the host vehicle speed being greater than the predetermined speed; the wireless message including at least a speed of the other vehicle, a length of the other vehicle and GPS coordinates of the other vehicle;
determining if the other vehicle is coupled to the host vehicle;
adding the length of the other vehicle to the length of the host vehicle to attain an overall length of the road train in response to the other vehicle being coupled to the host vehicle; and
transmitting to a braking controller the overall length of the road train and at least one of the GPS coordinates associated with the host vehicle and the heading of the host vehicle.
transmitting the overall length of the road train to a braking controller of the host vehicle and transmitting a message to a vehicle independent of the road train comprising the overall length of the road train and at least one of a GPS coordinate of the towing vehicle and the heading of the road train.

8. The controller as in claim 7, wherein the length of the road train is recalculated each time the controller is powered up.

9. The controller as in claim 7, the control logic further capable of receiving additional wireless messages until a timer initiated at the receipt of the first wireless message exceeds a predetermined time period prior to adding the length of the other vehicle to the length of the host vehicle.

10. The controller as in claim 9, wherein the predetermined time period is about ten seconds.

11. The controller as in claim 7, wherein determining if the other vehicle is coupled to the host vehicle comprises comparing the speed of the other vehicle and the speed of the host vehicle and determining that the speed of the other vehicle is less than a predetermined speed of the speed of the towing vehicle.

12. The controller as in claim 7, wherein determining if the other vehicle is coupled to the host vehicle comprises comparing the GPS coordinates of the other vehicle with the GPS coordinates of the host vehicle and determining that the GPS coordinates of the other vehicle places the other vehicle within a predetermined proximity of the host vehicle.

13. The controller as in claim 7, wherein determining if the other vehicle is coupled to the host vehicle comprises comparing the heading of the other vehicle with the heading of the host vehicle and determining that the heading of the other vehicle is less than a predetermined angle threshold with the heading of the host vehicle.

14. The controller as in claim 7, the control logic further capable of:
receiving a second wireless message from a second other vehicle at the wireless port subsequent to the host vehicle speed being greater than a predetermined speed;
determining the second other vehicle is coupled to the host vehicle;
adding the length of the second other vehicle to the length of the other vehicle and the host vehicle to attain an overall length of the road train in response to the second other vehicle being coupled to the host vehicle; and
transmitting the overall length of the road train and GPS coordinates associated with the host vehicle.

15. The controller as in claim 7, wherein the wireless port is configured for wireless communication using at least one of a Dedicated Short Range Communications (DSRC), Bluetooth, ZigBee and Wi-Fi protocol.

16. A controller on a tractor for determining a length of a road train comprising:
a wireless port for transmitting and receiving wireless messages;
an input for receiving a speed of the tractor;
a global positioning system (GPS) receiver; and
control logic, the control logic having a memory programmed with the length of the tractor and capable of:
receiving a first wireless message from a first trailer at the wireless port subsequent to the tractor speed being greater than a predetermined speed; the wireless message including at least a speed of the first trailer and GPS coordinates associated with the physical location of a transmitter on the first trailer;
comparing the speed in the first wireless message to the speed of the tractor;
determining a length of the first trailer based on the GPS coordinates;
adding the length of the first trailer to the length of the tractor to attain an overall length of the road train in response to the speed information in the first wireless message being equivalent to the speed of the tractor; and
transmitting the overall length of the road train and GPS coordinates associated with the tractor to at least one of an anti-lock brake controller, stability controller and an automatic cruise with braking controller.

17. The controller as in claim 16, the control logic further capable of:
receiving a second wireless message from a second trailer at the wireless port subsequent to the tractor speed being greater than a predetermined speed;
comparing the speed information in the second wireless message to the speed of the tractor;
adding the length of the second trailer to the length of the first trailer and the tractor to attain an overall length of the road train in response to the speed information in the second wireless message being equivalent to the speed of the tractor; and
transmitting the overall length of the road train and GPS coordinates associated with the tractor.

18. The controller as in claim 16, the control logic further capable of: determining the position of the first trailer and the second trailer in the road train based on the GPS coordinates of the first trailer, the second trailer and the tractor.

19. (canceled)

20. A method of determining a length of a road train comprising:
receiving a host vehicle speed;
comparing the host vehicle speed to a predetermined speed;
receiving a first wireless message from a first vehicle subsequent to the host vehicle speed being greater than the predetermined speed, the wireless message including at least a speed of the first vehicle, a length of the first vehicle, a heading of the first vehicle and GPS coordinates associated with the first vehicle;
determining if the first vehicle is coupled to the host vehicle;
adding the length of the vehicle to the length of the host vehicle to attain an overall length of the road train in response to the first vehicle being coupled to the tractor; and
transmitting the overall length of the road train to a braking controller of the host vehicle and transmitting wirelessly at least one of the GPS coordinates associated with the host vehicle, the overall length of the road train and the heading of the host vehicle.

21. (canceled)

22. The method as in claim 20, wherein determining if the first vehicle is coupled to the host vehicle comprises comparing the speed of the first vehicle and the speed of the host vehicle and determining that the speed of the first vehicle is less than a predetermined speed of the speed of the host vehicle.

23. The method as in claim 20, wherein determining if the first trailer is coupled to the tractor comprises comparing the GPS coordinates of the first trailer with the GPS coordinates of the tractor and determining that the GPS coordinates of the first trailer places the first trailer within a predetermined proximity of the tractor.

24. The method as in claim 20, wherein determining if the first trailer is coupled to the tractor comprises comparing the heading of the first trailer with the heading of the tractor and determining that the heading of the first trailer is less than a predetermined angle threshold with the heading of the tractor.

25. The method as in claim 20, wherein the first wireless message includes a vehicle type and determining if the first vehicle is coupled to the tractor comprises determining the type of the first vehicle is a commercial vehicle trailer.

26. The method as in claim 20, further comprising:
receiving a second wireless message from a second trailer at the wireless port subsequent to the tractor speed being greater than a predetermined speed;
comparing the speed information in the second wireless message to the speed of the tractor;
adding the length of the second trailer to the length of the first trailer and the tractor to attain an overall length of the road train in response to the speed information in the second wireless message being equivalent to the speed of the tractor; and
transmitting the overall length of the road train and GPS coordinates associated with the tractor.

27. A method for determining the length of a road train comprising:
receiving a host vehicle speed;
receiving a road train weight value;
preparing to receive wireless messages subsequent to the host vehicle speed being greater than a predetermined speed;
determining an overall length of the road train as a predetermined minimum length in response to receiving no wireless messages at the host vehicle and the road train weight value exceeding the weight of the host vehicle; and
transmitting the overall length of the road train to a braking controller of the host vehicle.

28. A system for determining the length of a road train comprising
a plurality of transmitters for transmitting messages; and
a tractor controller, having a GPS receiver and capable of receiving the messages from each transmitter, the tractor controller capable of:
receiving a tractor speed;
receiving a first message from a first transmitter subsequent to the tractor speed being greater than a predetermined speed, the first message including at least a speed of the vehicle on which the first transmitter is located, a length of the vehicle and GPS coordinates associated with the vehicle;
comparing the speed in the first message to the speed of the tractor;
adding the length of the first vehicle to the length of the tractor to attain an overall length of the road train in response to the speed information in the first message being equivalent to the speed of the tractor; and
transmitting at least one of the GPS coordinates associated with the tractor, the overall length of the road train and the heading of the tractor wirelessly to a vehicle independent of the tractor.
